(19) United States
(12) Patent Application Publication
(10) Pub. No.: US 2013/0133837 A1
(43) Pub. Date: May 30, 2013

(54) SHEET PROCESSING APPARATUS

(71) Applicant: Tatsuhisa NARAOKA, Shizuoka (JP)

(72) Inventor: Tatsuhisa NARAOKA, Shizuoka (JP)

(21) Appl. No.: 13/671,339

(22) Filed: Nov. 7, 2012

Related U.S. Application Data
(60) Provisional application No. 61/564,850, filed on Nov. 29, 2011.

(51) Int. Cl. B32B 37/02

(52) U.S. Cl. CPC B32B 37/02
USPC 156/443

(57) ABSTRACT

According to an embodiment, a sheet processing apparatus typically includes a sheet processing unit and an application unit. The sheet processing unit includes a stacker for a sheet conveyed from an image forming apparatus to be stacked on and a folding blade configured to come into contact with a sheet stacked on the stacker and press the sheet into a nip between two sheet folding rollers to fold the sheet. The application unit is located upstream of the sheet processing unit in a conveyance direction. The application unit applies a pressure sensitive adhesive to a portion of the sheet to be pressed into by the folding blade, the portion extending in a direction orthogonal to the conveyance direction, the pressure sensitive adhesive producing adhesion when pressure is applied.

### CROSS-REFERENCE TO RELATED APPLICATION

This application is based upon and claims the benefit of priority from U.S. provisional application 61/564,850, filed on Nov. 29, 2011; the entire contents of which are incorporated herein by reference.

### TECHNICAL FIELD

Embodiments described herein relate generally to a technology for binding sheets.

### BACKGROUND

A conventionally known method for binding a plurality of sheets discharged from an image forming apparatus includes running a binding member such as a wire through a bundle of sheets and bending the ends of the binding member to bind the bundle of sheets.

With the conventional method, if the binding member is removed from the bundle of sheets to reuse the sheets, holes and scratches made in the sheets by the removal of the binding member can cause a sheet feeding failure when the sheets are inserted to an image forming apparatus.

### DESCRIPTION OF THE DRAWINGS

FIG. 1 is a block diagram showing the hardware configuration of a first embodiment;

FIG. 2 is a schematic block diagram of a sheet processing apparatus;

FIG. 3 is a diagram showing an application position of a pressure sensitive adhesive to a sheet;

FIG. 4 is a diagram showing sheets stacked on a stacker;

FIG. 5 is a diagram showing that a pressing roller presses the folding portions of sheets to form a folding line;

FIG. 6 is a diagram showing an operation for folding sheets in two by a folding blade;

FIG. 7 is a flowchart showing book binding processing;

FIG. 8 is a schematic block diagram of a sheet processing apparatus according to a second embodiment; and

FIG. 9 is a diagram showing an application area of a pressure sensitive adhesive.

### DETAILED DESCRIPTION

According to an embodiment, a sheet processing apparatus typically includes a sheet processing unit and an application unit. The sheet processing unit includes a stacker and a folding blade. Sheets conveyed from an image forming apparatus are stacked on the stacker. The folding blade comes into contact with the sheets stacked on the stacker and presses the sheets into a nip between two sheet folding rollers to fold the sheets. The application unit is located upstream of the sheet processing unit in the conveyance direction. The application unit applies a pressure sensitive adhesive, which provides adhesion when pressure is applied, to portions of the sheets to be pressed into by the folding blade. The portions extend in a direction orthogonal to the conveyance direction.

Embodiments will be described below with reference to the drawings.

### First Embodiment

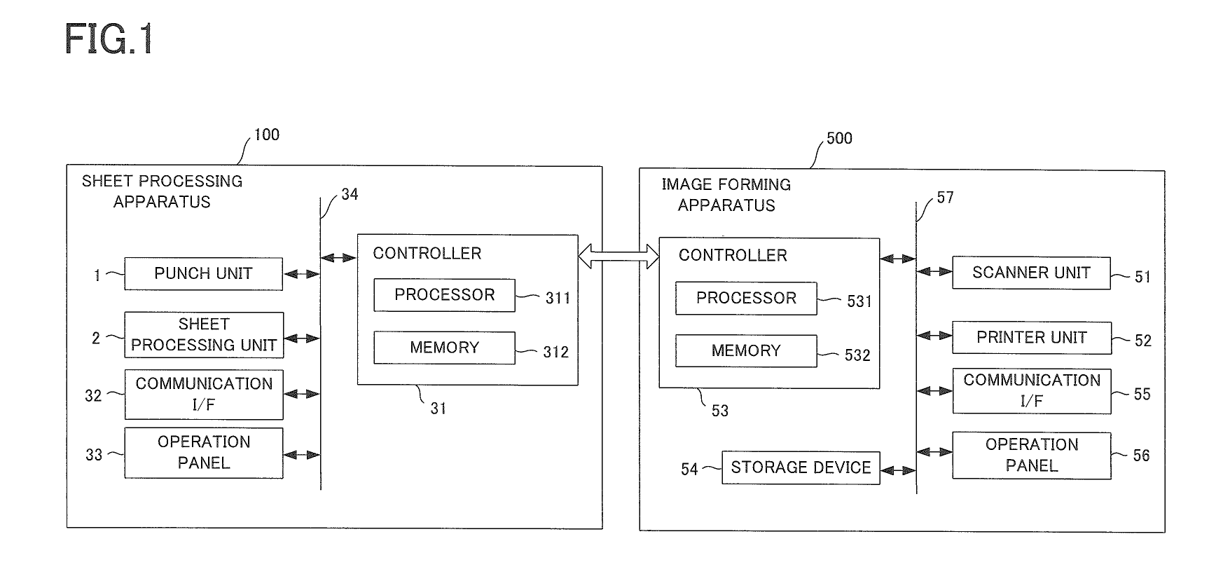

FIG. 1 is a block diagram showing the hardware configuration of a sheet processing apparatus 100 and an image forming apparatus 500.

The sheet processing apparatus 100 performs post-processing such as stapling and perforation on a sheet that is discharged from the image forming apparatus 500 such as a multi function peripheral (MFP). The sheet processing apparatus 100 also performs bookbinding processing for binding a bundle of sheets into a book.

The sheet processing apparatus 100 includes a punch unit 1, a sheet processing unit 2, a controller 31, a communication interface (I/F) 32, and an operation panel 33. Such components are connected by a bus 34. The punch unit 1 performs perforation processing and the like. The sheet processing unit 2 performs staple processing and the book binding processing. The controller 31 controls the entire sheet processing apparatus 100. The controller 31 includes a processor 311 which performs various types of operations, and a memory 312 which stores programs and the like read by the processor 311. The communication I/F 32 is an interface for connection to external devices. The communication I/F 32 transmits and receives data to/from the image forming apparatus 500 and the like in a wireless or wired manner. The operation panel 33 is a touch panel and accepts user's operation inputs. The operation panel 33 displays setting information, an operation status, and log information of the sheet processing apparatus 100, and notifications to the user.

The image forming apparatus 500 includes a scanner unit 51, a printer unit 52, a controller 53, a storage device 54, a communication I/F 55, and an operation panel 56. Such components are connected by a bus 57. The scanner unit 51 reads an image on a sheet placed on a document platen or the like. The printer unit 52 forms an image on a sheet based on the image data read by the scanner unit 51. The controller 53 controls the entire image forming apparatus 500. The controller 53 includes a processor 531 which performs various types of operations, and a memory 532 which stores programs and the like read by the processor 531. The storage device 54 stores various types of programs, jobs, and the like. The communication I/F 55 is an interface for connection to external devices. The communication I/F 55 transmits and receives data to/from external devices, the sheet processing apparatus 100, and the like in a wireless or wired manner. The operation panel 56 is a touch panel and accepts user's operation inputs. The operation panel 56 displays setting information, an operation status, and log information of the image forming apparatus 500, and notifications to the user.

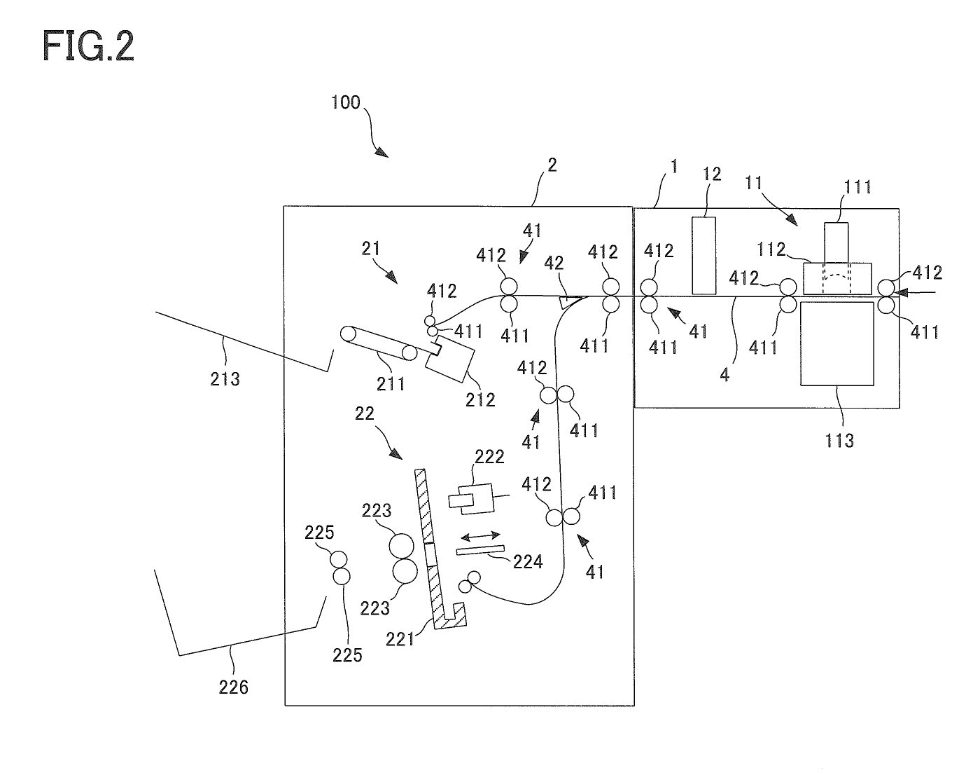

FIG. 2 is a schematic block diagram of the sheet processing apparatus 100.

The sheet processing apparatus 100 includes the punch unit 1 and the sheet processing unit 2.

A conveyance path 4 for conveying a sheet discharged from the image forming apparatus 500 is laid across the punch unit 1 and the sheet processing unit 2. The conveyance path 4 branches in the sheet processing unit 2. A staple processing section 21 which performs the staple processing is arranged on either one of the branches. A book binding section 22 which performs the book binding processing for binding a plurality of sheets into a book is arranged on the other branch. Conveyance rollers 41 are arranged on various positions of the conveyance path 4. A flapper 42 is provided at the branching point.

The conveyance rollers 41 include driving rollers 411 and driven rollers 412 opposed to the driven rollers 411 with a sheet interposed therebetween. The driving rollers 411 are located on a side of the conveyance path 4 where a folding blade 224 to be described later will not make contact with a sheet surface. The driving rollers 411 have high rigidity and are set to a friction coefficient sufficient to convey a sheet. The driven rollers 412 may be made of a resin or have a rubber or other elastic layer on their periphery. The driven rollers 412 are in contact with the driving rollers 411. The driven rollers 412 are located on the side of the sheet surface with which the folding blade makes contact and where the image forming apparatus 500 forms an image when performing single-sided printing. The driven rollers 412 are located on the side of the sheet surface where an application section 12 applies a pressure sensitive adhesive to. The driven rollers 412 have a layer of fluorine resin (such as a polyfluoroethylene resin) at the surface, whereby the friction coefficient of the driven rollers 412 is set to be lower than that of the driving rollers 411.

The punch unit 1 is interposed between the not-shown image forming apparatus 500 and the sheet processing unit 2. The punch unit 1 performs the perforation processing and the processing for applying a pressure sensitive adhesive to be described later on a sheet discharged from the image forming apparatus 500. The punch unit 1 includes a perforation section 11 and the application section 12. The perforation section 11 includes a punch blade 111, a punch guide 112, and a dust box 113. The punch blade 111 moves in a vertical direction in FIG. 2 to make a hole in a sheet. The punch guide 112 guides the vertical movement of the punch blade 11. The dust box 113 accommodates punch dust.

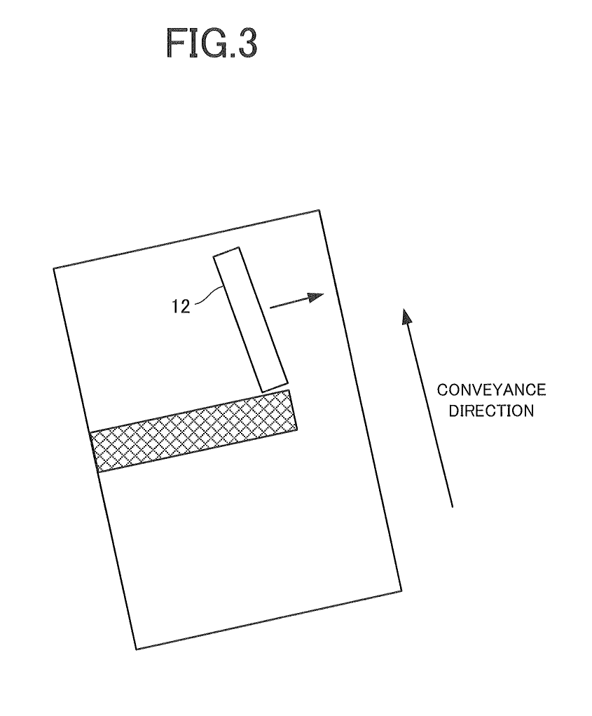

FIG. 3 is a diagram showing the application position of the pressure sensitive adhesive to a sheet.

The application section 12 is located upstream of the sheet processing unit 2 in the conveyance direction. The application section 12 applies the pressure sensitive adhesive, which produces adhesion when pressure is applied, to a folding portion of the sheet to be pressed into by the folding blade 224 to be described later. The folding portion extends in a direction orthogonal to the sheet conveyance direction (the direction orthogonal to the plane of FIG. 2, the lateral direction in FIG. 3; hereinafter, referred to as a sheet width direction). When the application section 12 applies the pressure sensitive adhesive to a sheet, the sheet is sandwiched by conveyance rollers 41 or other means to stop being conveyed. In the present embodiment, the application section 12 applies the pressure sensitive adhesive sheet by sheet.

The application section 12 may apply the pressure sensitive adhesive by using a roller. The application section 12 may apply the pressure sensitive adhesive by using an inkjet printer head that discharges the pressure sensitive adhesive by driving a piezoelectric element or a thermal element.

In the present embodiment, the application section 12 is included in the punch unit 1. The punch unit 1 is located upstream in the conveyance direction and at a sufficient distance from the book binding section 22 which performs the book binding processing with the folding blade 224.

Consequently, the pressure sensitive adhesive dries sufficiently before the sheet reaches the bookbinding section 22. This allows the pressure sensitive adhesive to fully exercise its adhesion. In the present embodiment, the application section 12 is located on the side of the sheet surface with which the driven rollers 412 covered with the fluorine resin make contact. Such a configuration can reduce sticking of the pressure sensitive adhesive to the rollers as compared to when the application section 12 is located on the side of the driving rollers 411.

The staple processing section 21 includes a conveyance belt 221, a stapler 212, and a discharge tray 213. Sheets discharged from the conveyance path 4 are stacked on a not-shown standby tray before dropped to the conveyance belt 211. The stapler 212 performs staple processing on the sheets placed and aligned on the conveyance belt 211. The conveyance belt 211 conveys and discharges the staple-processed sheets to the discharge tray 213.

The book binding section 22 includes a stacker 221, a pressing roller 222 (folding line forming mechanism), sheet folding rollers 223, the folding blade 224, conveyance rollers 225, and a discharge tray 226.

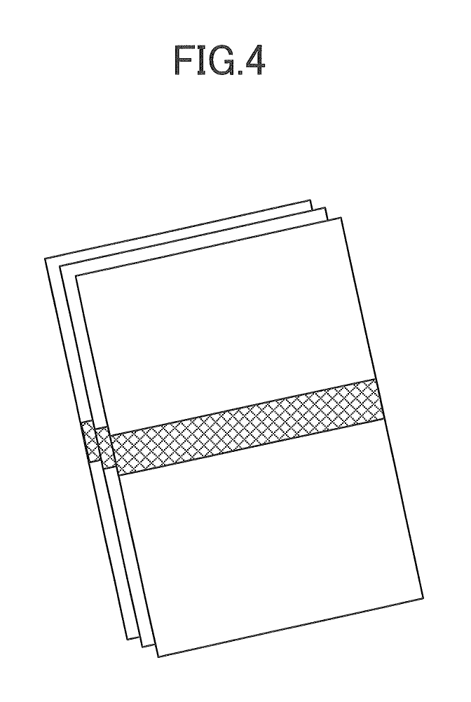

FIG. 4 is a diagram showing sheets stacked on the stacker 221.

Sheets are stacked on the stacker 221. The sheets are stacked in such an orientation that the application areas of the pressure sensitive adhesive fall on the side of the folding blade 224.

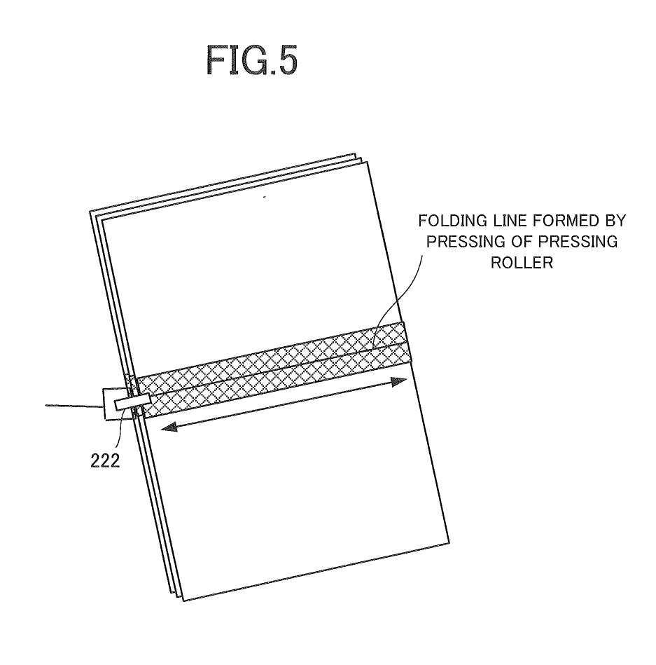

FIG. 5 is a diagram showing that the pressing roller 222 presses the folding portions of the sheets to form a folding line.

The pressing roller 222 is rotatably arranged. Each time a sheet is stacked on the stacker 221, the pressing roller 222 presses on the folding portion of the sheet where the pressure sensitive adhesive is applied, to form a folding line. Consequently, when the folding blade 224 folds the sheets in two afterward, the folds can be made more sharply to prevent the bound sheets, or book, from opening on itself. When the pressing roller 222 presses on the folding portion of the sheet where the pressure sensitive adhesive is applied, the sheets adhere to each other at the folding portions by the action of the pressure sensitive adhesive.

The pressing roller 222 may press a sheet by moving from one end to the other of the folding portion of the sheet where the pressure sensitive adhesive is applied. The pressing roller 222 may reciprocate over the folding portion of the sheet. The pressing roller 222 need not necessarily press the folding portions of the sheets each time a sheet is stacked. The intervals of sheets to press may be set as appropriate (for example, every five sheets). If the number of sheets to bind is small, the pressing roller 222 need not press the folding portions of the sheets.

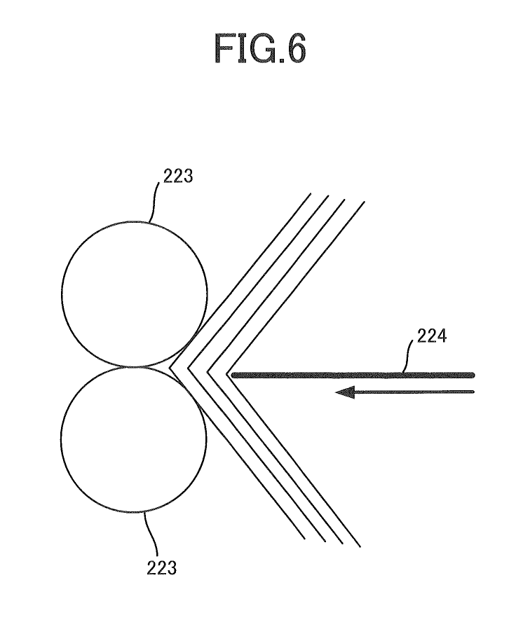

FIG. 6 is a diagram showing an operation for folding sheets in two by the folding blade 224. In FIG. 6, the stacker 221 is omitted.

The two sheet folding rollers 223 are opposed to the folding blade 224 with the stacker 221 therebetween (see FIG. 2).

The folding blade 224 comes into contact with the folding portions of the sheets where the pressure sensitive adhesive is applied, and presses the sheets into the nip between the sheet folding rollers 223 to fold the sheets in two. Here, the folding blade 224 applies a high pressure to the folding portions of the sheets, and the sheets are firmly adhered to each other at the folding portions by the action of the pressure sensitive adhesive.

The sheets folded in two are discharged to the discharge tray 226 by the sheet folding rollers 223 and the conveyance rollers 225.

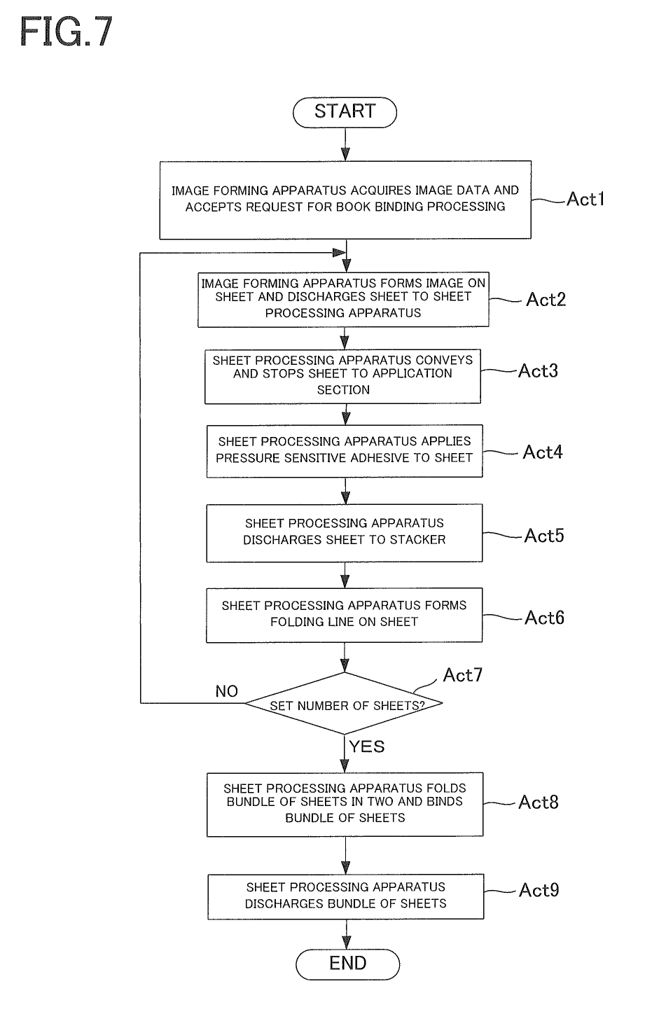

Now, the book binding processing of the image forming apparatus 500 and the sheet processing apparatus 100 will be briefly described with reference to the flowchart of FIG. 7.

The image forming apparatus 500 (controller 53) reads an image to acquire image data, or receives image data from an external device. The image forming apparatus 500 also accepts a request for the book binding processing (Act1). The image forming apparatus 500 forms an image on a sheet based on the image data, and discharges the sheet to the sheet processing apparatus 100 (Act2).

The sheet processing apparatus 100 (controller 31) acquires signals needed for the book binding processing (including the number of sheets set for the book binding processing, various settings of the book binding processing, and a sheet discharge signal) from the image formation 500, and performs the following processing. Initially, the sheet processing apparatus 100 (controller 31) conveys the sheet discharged from the image forming apparatus 500 to the application section 12, and stops conveyance at that position (Act3).

Using the application section 12, the sheet processing apparatus 100 applies the pressure sensitive adhesive to the folding portion of the sheet in the sheet width direction (Act4).

The sheet processing apparatus 100 discharges the sheet to the stacker 221 (Act5).

Using the pressing roller 222, the sheet processing apparatus 100 presses the folding portion of the sheet where the pressure sensitive adhesive is applied. This forms a folding line in the folding portion and makes folding portions adhere to each other by the action of the pressure sensitive adhesive (Act6).

The sheet processing apparatus 100 repeats such processing (Act7: NO, Act2 to Act6). If a set number of sheets are stacked on the stacker 221 (Act7: YES), the sheet processing apparatus 100 folds the bundle of sheets in two and binds the bundle of sheets by using the folding blade 224 (Act8).

The sheet processing apparatus 100 discharges the bound bundle of sheets to the discharge tray 226 (Act9).

### Second Embodiment

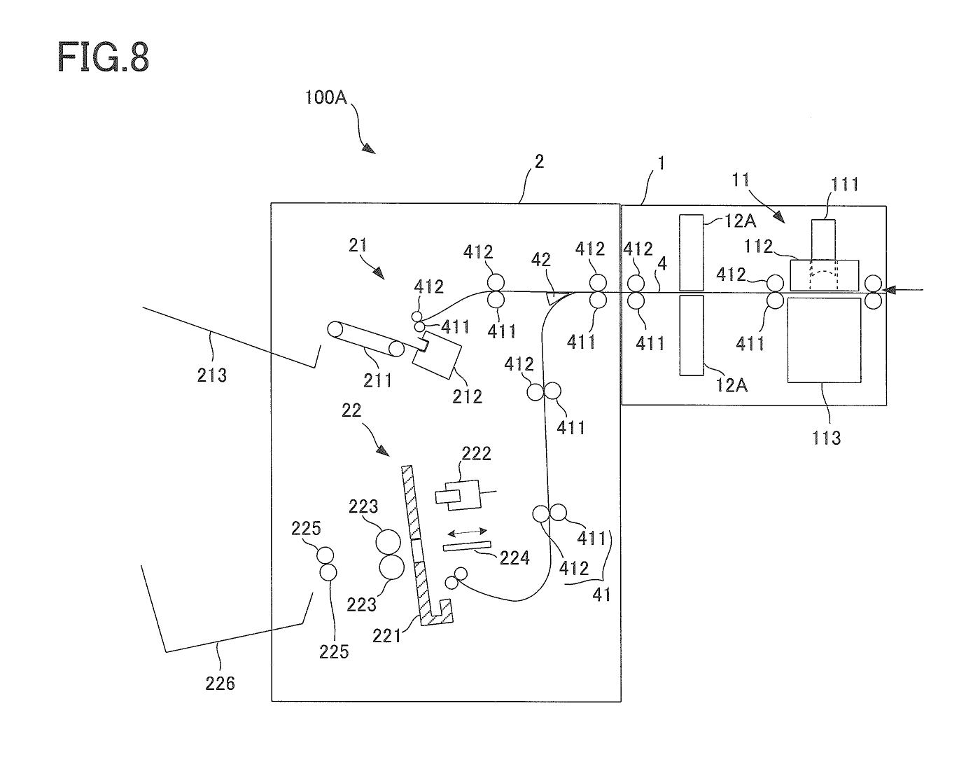

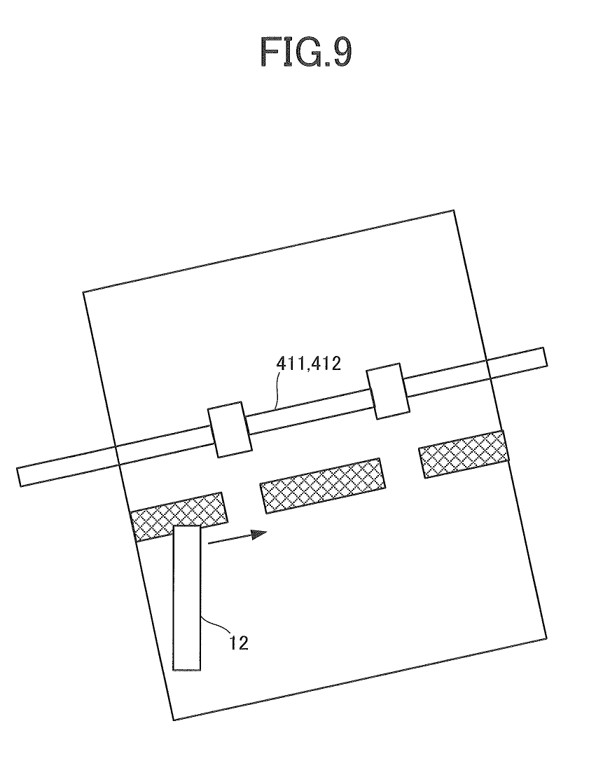

FIG. 8 is a schematic block diagram of a sheet processing apparatus 100A. FIG. 9 is a diagram showing the application area of the pressure sensitive adhesive.

In the present embodiment, application sections 12A are opposed to each other with the conveyance path 4 interposed therebetween. Each application section 12A applies the pressure sensitive adhesive to a folding portion of a sheet to be pressed into by the folding blade 224, the folding portion extending in a sheet width direction. Here, the pressure sensitive adhesive is applied to areas excluding the areas where the conveyance rollers (driving rollers 411 and driven rollers 412) make contact. In the present embodiment, the application sections 12A apply the pressure sensitive adhesive to both sides of the sheet.

The individual processes of the foregoing embodiments may be performed in different order than discussed in the embodiments.

As has been described in detail above, according to the technology described in this specification, it is possible to provide a technology for binding sheets.

While certain embodiments have been described, these embodiments have been presented by way of example only, and are not intended to limit the scope of invention. Indeed, the novel apparatus, methods and system described herein may be embodied in a variety of other forms; furthermore, various omissions, substitutions and changes in the form of the apparatus, methods and system described herein may be made without departing from the spirit of the inventions. The accompanying claims and their equivalents are intended to cover such forms or modifications as would fall within the scope and spirit of the inventions.

What is claimed is:

1. A sheet processing apparatus comprising:
a sheet processing unit including a stacker for a sheet conveyed from an image forming apparatus to be stacked on and a folding blade configured to come into contact with a sheet stacked on the stacker and press the sheet into a nip between two sheet folding rollers to fold the sheet; and
an application unit located upstream of the sheet processing unit in a conveyance direction, the application unit being configured to apply a pressure sensitive adhesive to a portion of the sheet to be pressed into by the folding blade, the portion extending in a direction orthogonal to the conveyance direction, the pressure sensitive adhesive producing adhesion when pressure is applied.

2. The sheet processing apparatus according to claim 1, wherein:
a conveyance path configured to convey the sheet from the application unit to the stacker includes a driving roller and a driven roller opposed to the driving roller with the sheet interposed therebetween; and
the application unit applies the pressure sensitive adhesive to a sheet surface with which the driven roller makes contact.

3. The sheet processing apparatus according to claim 1, wherein:
a conveyance path configured to convey the sheet from the application unit to the stacker includes a conveyance roller; and
the application unit applies the pressure sensitive adhesive to an area of a portion of the sheet to be pressed into by the folding blade, the portion extending in the direction orthogonal to the conveyance direction, the area excluding an area where the conveyance roller makes contact.

4. The sheet processing apparatus according to claim 1, wherein
the application unit applies the pressure sensitive adhesive to both sides of the sheet.

5. The sheet processing apparatus according to claim 1, comprising a pressing roller configured to press the sheet along the portion to be pressed into by the folding blade.
